(19) United States
(12) Patent Application Publication
(10) Pub. No.: US 2013/0327570 A1
(43) Pub. Date: Dec. 12, 2013

(54) METHODS AND SYSTEMS FOR COUPLING DIFFERENT SIZE BUSWAY SECTIONS

(71) Applicants: Kuldeep Kumar Bhathija, Secunderabad (IN); Steven English Richard, Selmer, TN (US); Michael Richard Wood, Southington, CT (US); Jeffery Lynn Cox, Selmer, TN (US)

(72) Inventors: Kuldeep Kumar Bhathija, Secunderabad (IN); Steven English Richard, Selmer, TN (US); Michael Richard Wood, Southington, CT (US); Jeffery Lynn Cox, Selmer, TN (US)

(21) Appl. No.: 13/489,956

(22) Filed: Jun. 6, 2012

(51) Int. Cl. H02G 15/08

(52) U.S. Cl. 174/88 R

(57) ABSTRACT

A reducer joint for interconnecting different size busway sections is described. The reducer joint includes a stack of a plurality of rectangular conductive plates, and a cover coupled to the stack. The stack has a first end for coupling to a first plurality of busbars of a first busway section and a second end opposite the first end for coupling to a second plurality of busbars of a second busway section. The cover defines a first opening adjacent the first end of the stack, the first opening having a first size and configured to receive the first plurality of busbars. The cover defines a second opening adjacent the second end of the stack, the second opening having a second size and configured to receive the second plurality of busbars. The first size and the second size are not identical.

### BACKGROUND OF THE INVENTION

The field of the disclosure relates generally to electrical power distribution using a busway system, and more specifically, to methods and systems for coupling different size busway sections within the busway system.

A busway system may be included within an electrical power distribution system. Busway systems typically include a plurality of busway sections joined together by joint sections to provide an appropriate length of busway. Busway systems are typically used in industrial or commercial buildings as an alternative to cable and conduit. Use of busway systems may decrease installation time and cost when compared to cable and conduit, and may also be a lower weight alternative to cable and conduit.

When two busway sections of different sizes are to be connected, a reducer joint is commonly used. At least some known systems utilize reducer joints fabricated from two different size busway sections. The busbars of the two different size busway sections are welded together with the flared portions of the busbars extending away from the welded portion. The housings of the two busway sections are welded together to create a housing for the reducer joint. The result is a straight connector with busway bars of a first size extending in one direction and busway bars of a second size extending in a second direction opposite the first direction. Each end of such a connector is identical to a standard busway section of the same size. Thus, to connect a busway section to the reducer joint, a basic connector, such as is used for connecting two straight busway sections of the same size together, must be used. Some known reducer joints constructed in this manner are relatively large, at about thirty six inches in length.

### BRIEF DESCRIPTION OF THE INVENTION

In one aspect, a reducer joint for interconnecting different size busway sections is described. The reducer joint includes a stack of a plurality of rectangular conductive plates, and a cover coupled to the stack. The stack has a first end for coupling to a first plurality of busbars of a first busway section and a second end opposite the first end for coupling to a second plurality of busbars of a second busway section. The cover defines a first opening adjacent the first end of the stack, the first opening having a first size and configured to receive the first plurality of busbars. The cover defines a second opening adjacent the second end of the stack, the second opening having a second size and configured to receive the second plurality of busbars. The first size and the second size are not identical.

In another aspect, a reducer joint for interconnecting different size busway sections includes a stack and a cover. The stack includes a plurality of pairs of conductive plates, and a plurality of insulative plates. Each conductive plate includes at least one integrally formed spacer. At least one insulative plate is disposed between adjacent ones of the plurality of pairs of conductive plates. The cover includes a first side cover component removably coupled to a first side of the stack, and a second side cover component removably coupled to a second side of said stack opposite the first side. The first side cover component and the second side cover component cooperatively define a first aperture configured to receive a first plurality of busbars of a first busway section for coupling to the plurality of pairs of conductive plates. The first side cover component and the second side cover component cooperatively define a second aperture for receiving a second plurality of busbars of a second busway section for coupling to the plurality of pairs of conductive plates. The first aperture has a first size, the second aperture has a second size, and the first size is not identical to the second size.

In yet another aspect, a power distribution system includes a first busway section including a plurality of first busway bars of a first width, a second busway section including a plurality of second busway bars of a second width different than the first width, and a reducer joint coupled between the first busway section and the second busway section. The reducer joint includes a plurality of pairs of conductive plates, and a cover removably coupled to the plurality of pairs of conductive plates. Each pair of conductive plates is coupled in contact with a different one of the first busway bars and a different one of the second busway bars. The cover defines a first aperture and a second aperture opposite the first aperture. At least a portion of the first busway section is positioned within the first aperture, and at least a portion of the second busway section is positioned within the second aperture.

### BRIEF DESCRIPTION OF THE DRAWINGS

FIG. 1 is a perspective view of an exemplary embodiment of a busway electrical distribution system including a reducer joint.

FIG. 2 is a top view of the busway electrical distribution system shown in FIG. 1.

FIG. 3 is a side view of the busway electrical distribution system shown in FIG. 1.

FIG. 4 is a partially exploded perspective view of the busway electrical distribution system shown in FIG. 1.

FIG. 5 is an exploded view of the reducer joint shown in FIG. 1.

FIG. 6 is a perspective view of the reducer joint shown in FIG. 1.

FIG. 7 is another perspective view of the reducer joint shown in FIG. 1.

FIG. 8 is a partial cross sectional view of the busway electrical distribution system shown in FIG. 1.

### DETAILED DESCRIPTION OF THE INVENTION

The embodiments described herein include systems and methods for coupling different size busway sections in a busway system. The systems and methods provide reduced size, removable connections between different size busway sections in a busway system while sealing an interior of the busway system from contaminants. Moreover, the systems and methods facilitate reducing the labor and/or cost of producing such connections and/or connectors. The systems and methods may further provide electrical ground contact between the components.

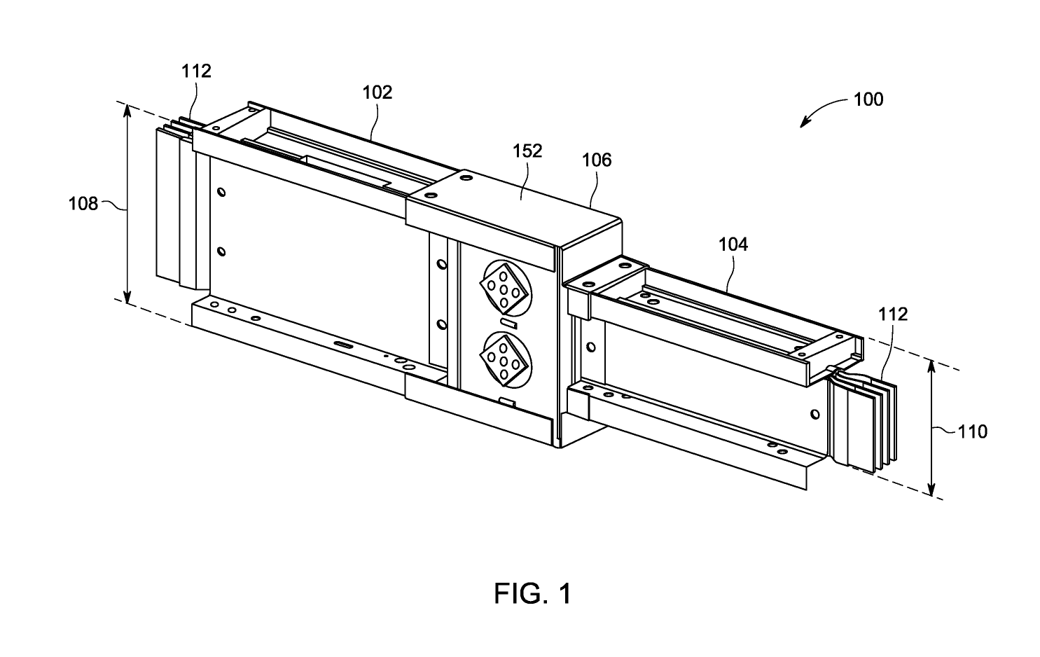

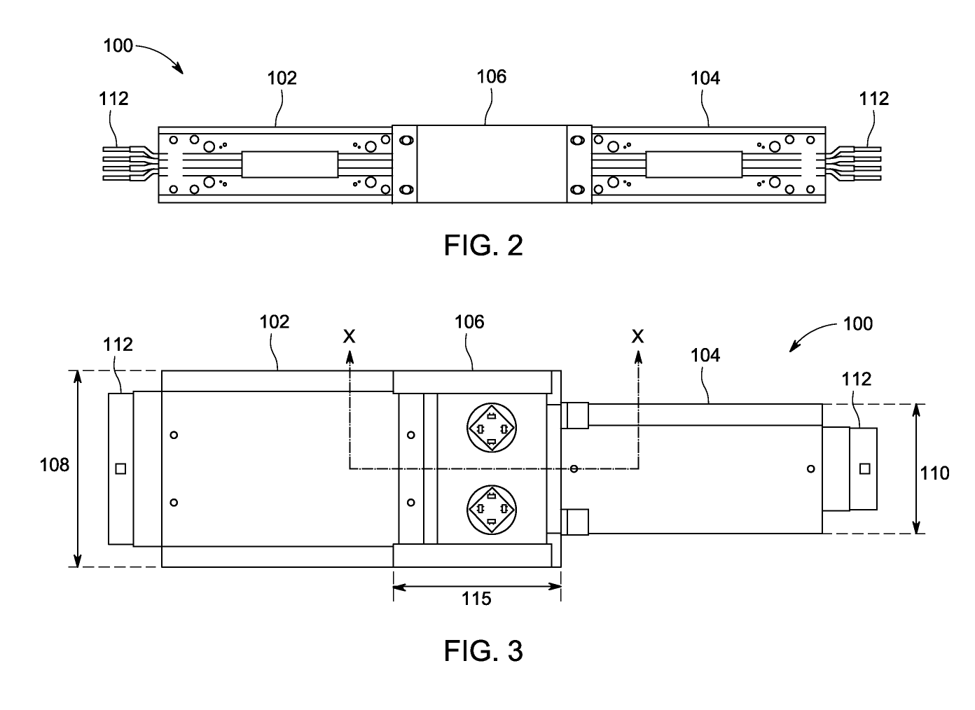

FIG. 1 is a perspective view of an exemplary embodiment of a busway electrical distribution system 100. FIG. 2 is a top view of system 100, and FIG. 3 is a side view of system 100. Busway electrical distribution system 100 includes a first busway section 102 and a second busway section 104. First busway section 102 and second busway section 104 are coupled together by a reducer joint 106, also referred to sometimes as a connector.

Busway sections 102 and 104 are different size busway sections. Specifically, a height 108 of first busway section 102 is greater than a height 110 of second busway section 104. Different size busway sections provide different current carrying capabilities or ratings. Generally, a larger busway section is rated to carry more current than a smaller busway section. In the exemplary embodiment, first busway section 102 has a higher current rating than second busway section 104.

Each busway section 102 and 104 includes a plurality of conductors 112 within a housing 114. The plurality of conductors 112, also referred to herein as busbars, extend completely through housing 114. In one embodiment, conductors 112 are fabricated from copper. In other embodiments, conductors 112 are fabricated from any other suitable conductive material including, for example, aluminum. In the exemplary embodiment, housing 114 is utilized as a ground path. In some embodiments, one of conductors 112 may be, additionally or alternatively, a grounding conductor. In one embodiment housing 114 is fabricated from aluminum. In other embodiments, housing 114 is fabricated from any other material suitable for housing conductors 112. In embodiments in which housing 114 is not utilized as a ground path, housing 114 may be fabricated from nonconductive materials.

In the exemplary embodiment, each of busway sections 102 and 104 includes three conductors 112. In other embodiments busway sections 102 and 104 may include more or fewer conductors 112. In some direct current (DC) systems, for example, busway sections 102 and 104 each include two conductors 112, while some three phase systems include busway sections 102 and 104 having four or five conductors 112.

Reducer joint 106 couples first busway section 102 and second busway section 104 to each other. More specifically, reducer joint 106 couples conductors 112 of first and second busway sections 102 and 104 to each other. In the exemplary embodiment, reducer joint 106 also couples together housing 114 of each busway section 102 and 104 ensuring proper grounding between first busway section 102 and second busway section 104.

In the example embodiment, reducer joint 106 has a length 115 (shown in FIG. 3), of about eight inches. In other embodiments, reducer joint 106 may have any other suitable length 115. Preferably, reducer joint 106 has a length 115 of less than thirty six inches. In other embodiments, reducer joint 106 has a length 115 of less than twenty four inches. In still other embodiments, reducer joint 106 has a length 115 of less than about twelve inches.

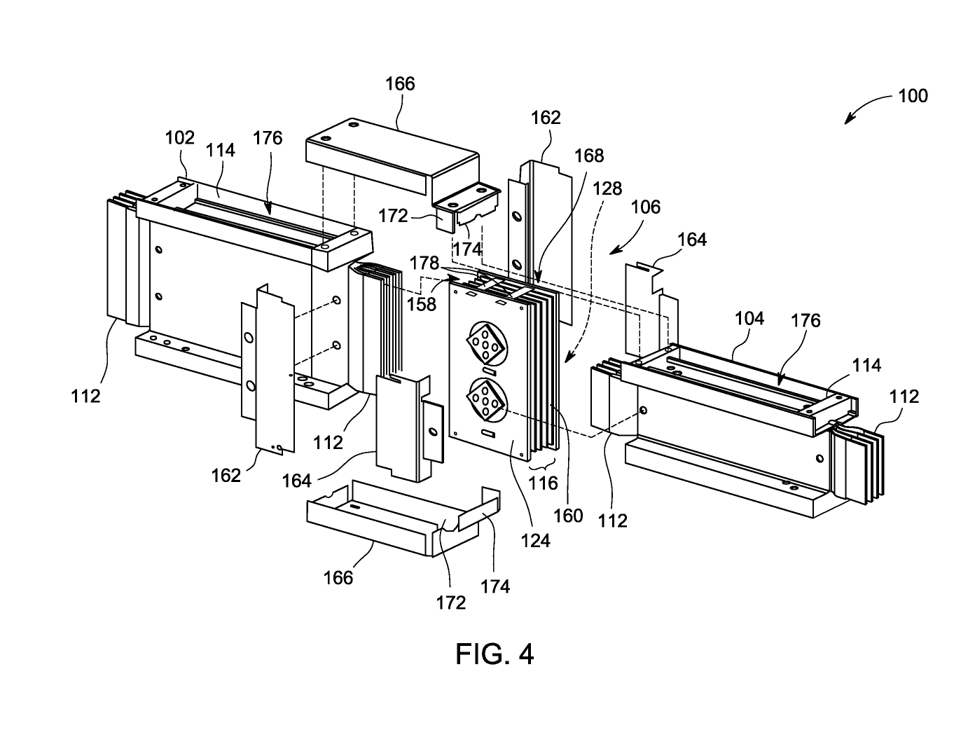

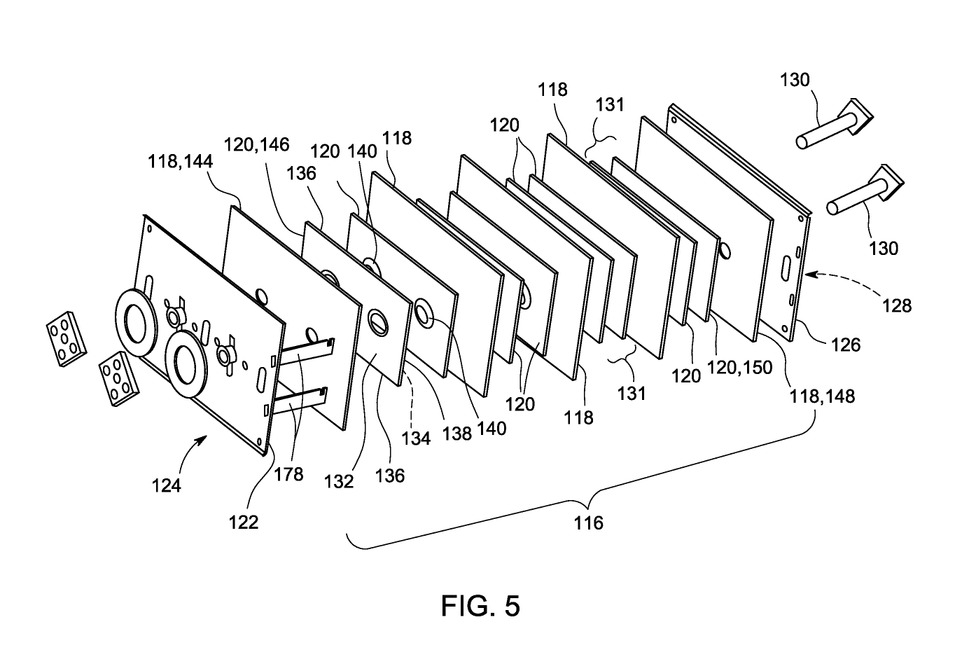

Reducer joint 106 will be described with further reference now to FIGS. 4 and 5. FIG. 4 is an exploded view of system 100, and FIG. 5 is an exploded view of reducer joint 106. Reducer joint 106 includes a stack 116 of alternating insulator plates 118 and conductive plates 120 (also sometimes referred to as plate conductors). A first cover plate 122 is positioned adjacent a top 124 of stack 116, and a second cover plate 126 is positioned adjacent a bottom 128 of stack 116. Fasteners 130 extend through first cover plate 122, stack 116, and second cover plate 126 to physically couple first cover plate 122, stack 116, and second cover plate 126 together. In one embodiment, fasteners 130 are bolts. In alternative embodiments, fasteners 130 are other devices configured to couple first cover plate 122, stack 116, and second cover plate 126 together.

Conductive plates 120 are arranged in stack 116 in a plurality of adjacent pairs 131 (shown in FIG. 5). Conductive plates 120 in an adjacent pair 131 are not separated from each other by an insulator plate 118. Each adjacent pair 131 is configured to couple to one conductor 112 of first busway section 102 and second busway section 104 to physically and electrically couple first and second busway sections 102 and 104 to each other.

In the exemplary embodiment, conductive plates 120 are fabricated from copper. In other embodiments, any other suitable electrically conductive material, or combination of materials, may be used to fabricate conductive plates 120. Conductive plates 120 are substantially planar plates having a first planar surface 132 and a second planar surface 134 opposite first planar surface 132. As shown in FIG. 5, conductive plates 120 are substantially rectangular shaped and have two sides 136 that are larger than two sides 138. In other embodiments sides 136 are the same length as sides 138 (i.e., conductive plates 120 are square-shaped). In the exemplary embodiment, conductive plates 120 are made of a copper sheet. In other embodiments, the fabrication material includes other suitable conductive materials, such as aluminum. Moreover, the material may itself comprise more than one component, including alloys, layers, platings, etc. Conductive plates 120 are fabricated from the material monolithically, e.g. without welding or soldering multiple pieces of the material together to form the shape of conductive plate 120 and may be formed, for example, by stamping, cutting, molding, etching, or any other suitable technique for monolithically forming the material into conductive plates 120.

Insulator plates 118 separate, both physically and electrically, adjacent pairs 131 of conductive plates 120 from a neighboring adjacent pair 131 of conductive plates 120. Thus, each insulator plate 118 is positioned between two conductive plates 120 in stack 116 to facilitate preventing electrical or physical connection of the two adjacent conductive plates 120 that are not part of an adjacent pair 131. In the exemplary embodiment, insulator plates are thermoset fiberglass-reinforced polyester insulators. In other embodiments, any other suitable insulating material may be used to fabricate insulator plates 118. In some embodiments more than one insulator plate 118 may be positioned between adjacent conductive plates 120.

In the exemplary embodiment, insulator plates 118 have substantially the same shape as conductive plates 120 and are slightly larger than conductive plates 120. In other embodiments, insulator plates 118 may have any other suitable shape and size. In some embodiments, insulator plates 118 are not a single plate, but include multiple plates.

Stack 116 includes one or more spacers 140 for increasing the physical separation of adjacent pairs 131 of conductive plates 120. Spacers 140 are integrally formed in conductive plates 120. More specifically, spacers 140 are formed around bolt holes 142, through which fasteners 130 pass when stack 116 is assembled. Other embodiments may include more or fewer spacers 140, including no spacers 140. Moreover, other embodiments may, additionally or alternatively, include spacers 140 that are not integrally formed in conductive plates 120, are formed in insulator plates 118, are separately attached to insulator plates 118 and/or conductive plates, and/or are located other than around bolt holes 142.

Insulator plates 118 are also positioned to separate, both physically and electrically, conductive plates 120 from first and second cover plates 122 and 126. More specifically, a top insulator plate 144 separates a top conductor plate 146 from first cover plate 126. A bottom insulator plate 148 separates a bottom conductor plate 150 from second cover plate 126. Thus, insulator plates 144 and 148 facilitate preventing electrical connection or physical contact between first and second cover plate 122 and 126 and conductive plates 120 (and more specifically top and bottom conductive plates 146 and 126).

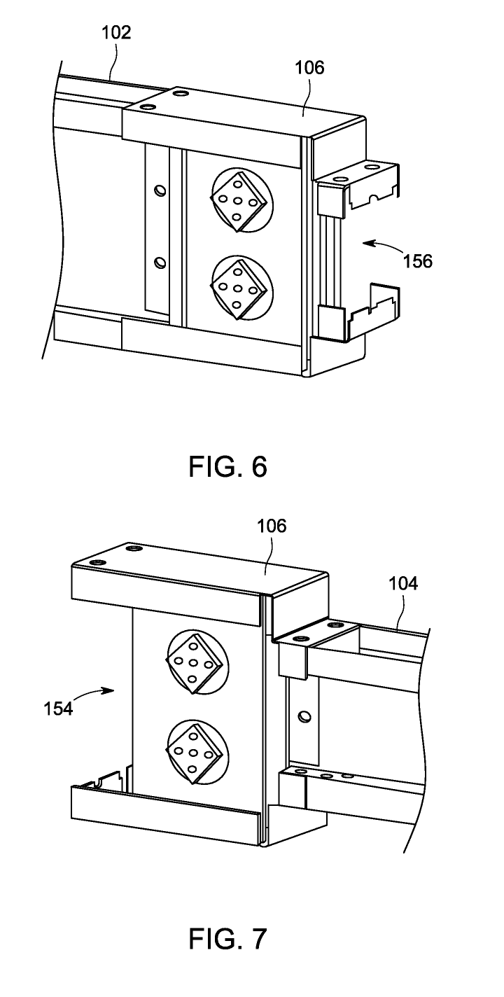

Reducer joint 106 includes a cover 152 to provide additional protection, e.g. prevention of ingress of material, dust, etc., to reducer joint 106 and, more particularly, to stack 116. Moreover, as shown in FIGS. 6 and 7 cover 152 defines a first opening 154 (sometimes referred to as a first aperture) to receive conductors 112 of first busway section 102, and defines a second opening 156 (sometimes referred to as a second aperture) to receive conductors 112 of second busway section 104. First opening 154 is located adjacent a first end 158 (shown in FIG. 4) of stack 116, while second opening 156 is adjacent a second end 160 (also shown in FIG. 4) of stack 116. First opening 154 has a first size and second opening 156 has a second size. The first size is a different size than the second size, i.e. the first size and the second size are not identical. Specifically, the first size of first opening 154 is larger than the second size of second opening 156 in order to accommodate the larger sized first busway section 102.

Cover 152 includes first cover plate 122, second cover plate 126, first end cover components 162, second end cover components 164, and side cover components 166. First cover plate 122, second cover plate 126, first end cover components 162, second end cover components 164, and side cover components 166 are removably coupled to stack 116 and may be fabricated from any suitable material including, for example, steel, aluminum, plastic, and/or fiberglass.

Side cover components 166 are generally coupled to the remainder of reducer joint 106 alongside a third end 168 and a fourth end 170 (which are sometimes referred to as a first side and a second side) of stack 116 after reducer joint 106 is coupled to first and second busway sections 102 and 104. Side cover components 166 each include flanges 172 that are configured, e.g., sized, shaped, etc., to at least partially overlap housing 114. Moreover, side cover components 166 each include tabs 174 configured to be fit within a channel 176 within housing 114.

First cover plate 122 and second cover plate 126 cover the top and bottom of stack 116 and function as ground planes between first and second busway sections 102 and 104. First cover plate 122 and second cover plate 126 are physically and electrically coupled to each other by joint side connectors 178. Cover plates 122 and 126 are coupled to busway section 102 and 104 by first end cover components 162 and second end cover components 164. First and second end cover components 162 and 164 extend under and contact cover plates 122 and 126, and are fastened to busway sections 102 and 104, such as with screws, bolts, etc., when busway sections 102 and 104 are plugged into reducer joint 106. In the exemplary embodiment, first and second cover plates 122 and 126 are shaped substantially the same as conductive plates 120 and are fabricated from sheet steel. In other embodiments, first and second cover plates 122 and 126 may have any other suitable shape and/or may be fabricated from any other suitable electrically conductive material. In embodiments in which first and second cover plates 122 and 126 are not utilized as a ground path, first and second cover plates 122 and 126 may be fabricated from any nonconductive material suitable for covering the top and bottom of stack 116.

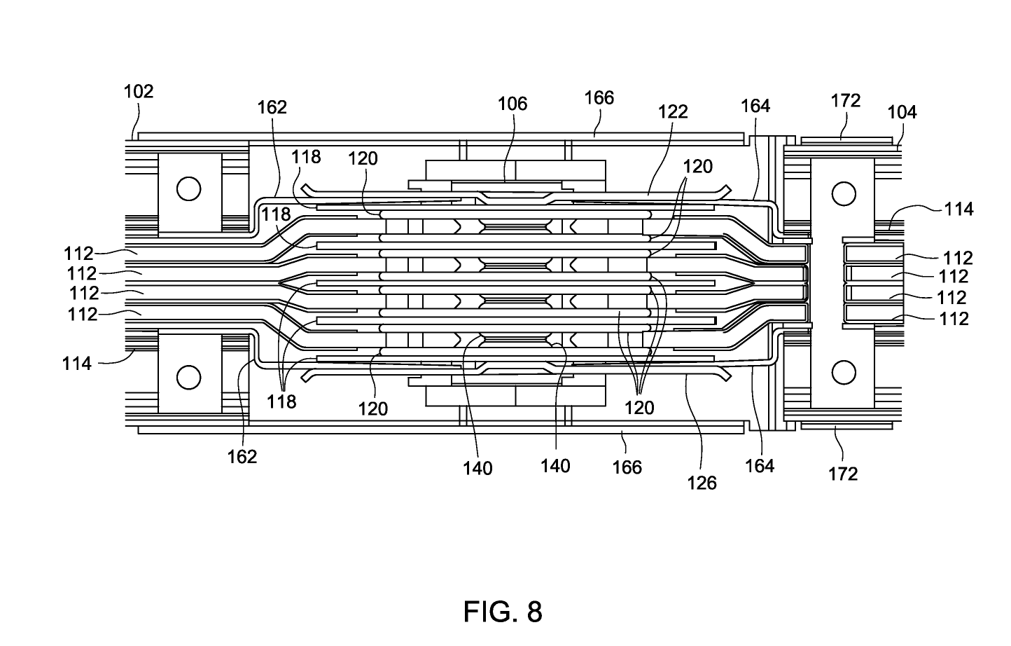

To perform an installation using reducer joint 106, first busway section 102 is inserted into first end 158 through first opening 154, and second busway section 104 is inserted into second end 160 through second opening 156. Fasteners 130 are tightened by the user to compress stack 116 to facilitate contact between conductors 112 and conductive plates 120 and to retain busway sections 102 and 104 coupled to reducer joint 106. Side cover components 166 are then positioned along third end 168 and fourth end 170. FIG. 8 is a cross sectional view of the assembled system 100 taken along the line x-x in FIG. 3.

Described herein are exemplary methods and systems for coupling together two different size busway sections. The exemplary reducer joint is formed without welding, thereby reducing production difficulty, cost, and/or time. Moreover, the exemplary reducer joint connects directly to busway sections. Thus, unlike some known systems, additional connectors for each busway section are not needed during installation. Moreover, the reducer joint include a removable cover made of separate cover pieces. These feature further reduce the production difficulty, cost, and/or time. Furthermore, the reducer joints in accordance with the present disclosure are smaller in size than some known reducer joints.

The methods and systems described herein facilitate efficient and economical manufacture and assembly of a busway based electrical distribution network. Exemplary embodiments of methods and systems are described and/or illustrated herein in detail. The methods and systems are not limited to the specific embodiments described herein, but rather, components of each system, as well as steps of each method, may be utilized independently and separately from other components and steps described herein. Each component, and each method step, can also be used in combination with other components and/or method steps.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A reducer joint for interconnecting different size busway sections, said reducer joint comprising:
a stack of a plurality of rectangular conductive plates, said stack having a first end configured to couple to a first plurality of busbars of a first busway section and a second end opposite the first end configured to couple to a second plurality of busbars of a second busway section; and
a cover coupled to said stack, said cover defining a first opening adjacent said stack first end, the first opening having a first size and configured to receive the first plurality of busbars, and defining a second opening adjacent said stack second end, the second opening having a second size and configured to receive the second plurality of busbars, wherein the first size and the second size are not identical.

2. A reducer joint in accordance with claim 1, wherein said plurality of conductive plates comprises pairs of conductive plates, said reducer joint further comprising a plurality of insulative plates, at least one plate of said plurality of insulative plates dispose between two adjacent said pairs of conductive plates.

3. A reducer joint in accordance with claim 2, further comprising a plurality of fasteners extending through said plurality of conductive plates and said plurality of insulating plates.

4. A reducer joint in accordance with claim 1, wherein said plurality of conductive plates comprises pairs of conductive plates, each said pair of conductive plates configured to couple to a at least one corresponding busbar of each of the first and second busway sections.

5. A reducer joint in accordance with claim 4, further comprising a plurality of insulative plates, wherein said insulative plates are positioned between two adjacent said pairs of conductive plates.

6. A reducer joint in accordance with claim 1, wherein said stack comprises a third and fourth end substantially perpendicular to said first and second end and said cover comprises a first side cover component adjacent said third end and a second side cover component adjacent said fourth end.

7. A reducer joint in accordance with claim 6, wherein said cover further comprises a top cover and a bottom cover and said stack comprises a top and a bottom, said top cover adjacent said top of said stack and said bottom cover adjacent said bottom of said stack.

8. A reducer joint in accordance with claim 7, wherein said cover comprises a first side cover component coupled to said top cover and said bottom cover and a second side cover component coupled to said top cover and said bottom cover.

9. A reducer joint in accordance with claim 1, wherein at least part of said cover is removably coupled to said stack.

10. A reducer joint in accordance with claim 1, wherein said stack is configured to be directly connected to busbars of a first busway section and a second busway section.

11. A reducer joint for interconnecting different size busway sections, said reducer joint comprising:
a stack comprising:
a first side and a second side;
a plurality of pairs of conductive plates, each conductive plate of plurality of pairs of conductive plates including at least one integrally formed spacer; and
a plurality of insulative plates, at least one insulative plate of said plurality of insulative plates disposed between adjacent pairs of said plurality of pairs of conductive plates; and
a cover comprising:
a first side cover component removably coupled to said first side of said stack; and
a second side cover component removably coupled to said second side of said stack, said first side cover component and said second side cover component cooperatively defining a first aperture configured to receive a first plurality of busbars of a first busway section for coupling each busbar of said plurality of busbars to a different pair of said plurality of pairs of conductive plates, and said first side cover component and said second side cover component cooperatively defining a second aperture for receiving a second plurality of busbars of a second busway section for coupling each busbar of said second plurality of busbars to a different pair of said plurality of pairs of conductive plates, wherein the first aperture has a first size, the second aperture has a second size, and the first size is not identical to the second size.

12. A reducer joint in accordance with claim 11, wherein said cover further comprises a top cover plate and a bottom cover plate

13. A reducer joint in accordance with claim 12, further comprising at least one joint side connector coupled between the top cover plate and the bottom cover plate.

14. A reducer joint in accordance with claim 11, wherein a length of said reducer joint is less than about twelve inches.

15. A reducer joint in accordance with claim 11, wherein said integrally formed spacers on each said conductive plate of at least one pair of conductive plates define a gap extending between the conductive plates of said pair of conductive plates, wherein the gap is sized to receive the busbars of the first and second busway sections.

16. A power distribution system comprising:
a first busway section including a plurality of first busway bars of a first width;
a second busway section including a plurality of second busway bars of a second width different than the first width; and
a reducer joint coupled between said first busway section and said second busway section, said reducer joint comprising:
a plurality of pairs of conductive plates, each pair of conductive plates contacting a different one of said first busway bars and a different one of said second busway bars;
a cover removably coupled to said plurality of pairs of conductive plates, said cover defining a first aperture and a second aperture opposite the first aperture, at least a portion of said first busway section positioned within the first aperture, at least a portion of said second busway section positioned within the second aperture.

17. A power distribution system in accordance with claim 16, wherein said first busway section includes a first housing and said second busway section includes a second housing, and wherein said cover is coupled to said first and second housings, at least a portion of said first housing is positioned within the first aperture, and at least a portion of said second housing is positioned within the second aperture.

18. A power distribution system in accordance with claim 17, wherein said cover comprises a top cover plate coupled to said first and second housings and a bottom cover plate coupled to said first and second housings.

19. A power distribution system in accordance with claim 18, further comprising at least one joint side connector coupled between said top cover plate and said bottom cover plate.

20. A power distribution system in accordance with claim 16, wherein said reducer joint is formed without welding.
